(19) United States
(12) Patent Application Publication
(10) Pub. No.: US 2011/0184922 A1
(43) Pub. Date: Jul. 28, 2011

(54) METHOD FOR FINDING FREQUENT ITEMSETS OVER LONG TRANSACTION DATA STREAMS

(75) Inventor: Won Suk LEE, Seoul (KR)

(73) Assignee: INDUSTRY-ACADEMIC COOPERATION FOUNDATION, YONSEI UNIVERSITY, Seoul (KR)

(21) Appl. No.: 13/008,686

(22) Filed: Jan. 18, 2011

(30) Foreign Application Priority Data
Jan. 18, 2010 (KR) 10-2010-0004391

(51) Int. Cl. G06F 17/30

(52) U.S. Cl. 707/693; 707/E17.002

(57) ABSTRACT

Provided is a method for finding frequent itemsets over logn transaction data streams. The method for finding frequent itemsets from data streams includes: (a) generating a plurality of projection tractions by projecting generated transactions; (b) mining each of the plurality of projection transactions by using a plurality of first layer prefix trees; (c) compressing the frequent itemsets generated at the first layer prefix tree to generate compressed itemsets; and (d) merging the generated compressed itemsets and mining the merged compressed itemsets by using a second layer prefix tree. Therefore, the present invention can effectively perform the frequent itemsets in the long transaction data stream environment.

### CROSS-REFERENCE TO RELATED APPLICATIONS

This application claims priority to and the benefit of Korean Patent Application No. 10-2010-0004391 filed in the Korean Intellectual Property Office on Jan. 18, 2010, the entire contents of which are incorporated herein by reference.

### TECHNICAL FIELD

The present invention relates to data mining, and more particularly, to a method for finding frequent itemsets from data streams that are a non-restrictive data set configured of continuously generated transactions.

### BACKGROUND

Generally, in a data set that is a target of data mining, all the pieces of unit information appearing in application domains are defined as a unit item and a set of the pieces of unit information having semantic simultaneity (that is, semantically simultaneously generated) in the application domains is defined as transaction. The transaction has information of unit items having the semantic simultaneity and a data set that is an analysis object of data mining is defined as a set of the transactions generated in the corresponding application domain.

Since the data streams are seamlessly input at various input rates and a storage space of a memory storing the data streams is limited, it is impossible to store all the pieces of information. Due to the characteristics, there are the following restrictions in extracting knowledge from the data streams. First, a user should read the transaction information of the data streams only once to extract semantic knowledge.[10] Second, even though the data streams are generated infinitively, they should be processed in a limited memory space. Third, newly generated data should be processed as soon as possible. Fourth, the extracted semantic knowledge for the data streams should be provided to the user whenever the user wants the extracted semantic knowledge. Due to these restrictions, the data stream mining methods lead to errors in mining results.

The mining methods [2, 5, 16, 19] for the existing frequent itemsets has several problems. First, in order to find the frequent itemsets of the data streams, since all the items of the transaction and all the itemsets having high frequent possibility are managed, the memory usage is increased. As a result, as the length (|Tk|) of the transaction is increased, the usage and run time of the memory is increased exponentially. When transaction having very large |Tk| due to many items is referred to as a long transaction, it is impossible to find the frequent itemsets under the long transaction data stream environment due to the above-mentioned reasons. Further, there is a case that cannot greatly help the decision of the user due to too many mining results. In order to solve the problems, a compression method of substituting a portion of the set of the mining results into specific presentation has been introduced.[25]

There are two compression methods. That is, there are lossless compression and lossy approximation. The former case, which has been known as closed frequent itemset (CFI)[23], can again recover all the sets of the frequently itemset but has a limited degree of compression. The latter case, which has been known as a maximal frequent itemset (MFI)[14], has high compression rate but loses information regarding support, such that it cannot again recover all the sets of the frequent itemset.

### SUMMARY

The present invention has been made in an effort to provide a new method for finding frequent itemsets over long transaction data streams.

An exemplary embodiment of the present invention provides a method for finding frequent itemsets from data streams, the method including: (a) generating a plurality of projection tractions by projecting generated transactions; (b) mining each of the plurality of projection transactions by using a plurality of first layer prefix trees; (c) compressing the frequent itemsets generated at the first layer prefix tree to generate compressed itemsets; and (d) merging the generated compressed itemsets and mining the merged compressed itemsets by using a second layer prefix tree.

During step (b), the plurality of first layer prefix trees may represent m-th first layer prefix tree by Pm.k {P_{1.k}, P_{2.k}, . . . , P_{m.k}} (M≧2) when the transaction Tk (where k is TID) is provided.

During step (b), the projection transaction Tm.k corresponding to the Pm. K may be represented as follow.

Tₖ={T_{1.k}∪T_{2.k}∪ . . . ∪T_{m.k}}_{(T1.k∩T2.k∩ . . . ∩Tm.k=Ø)}

Steps (c) and (d) may be performed when the frequent itemsets corresponding to a power set of the projection transaction is present in the first layer prefix tree during step (b).

Step (c) may generate the compressed itemsets when the frequent itemsets x and y generated at the first layer prefix tree have a difference in support smaller than a predetermined threshold value ω(0≦ω≦1) while having a relationship of a subset with a superset.

The merge of the compressed itemsets during step (d) may be performed in a type that concatenates a first compressed itemset generated at the first layer prefix tree to m-th compressed itemset generated at the first layer prefix tree.

When the new transaction Tk is generated, the second layer prefix tree may be represented by Bk and when tuples generated by the merge results of the compressed itemsets is the sub-transaction Uk, step (d) may includes updating appearance frequency and node performed while finding Bk−1 by a dictionary order of the items of the Uk.

The updating of the appearance frequency and node may sum items corresponding to two first layer prefix trees of the sub-transactions and increase the appearance frequency for each node found while finding the Bk−1.

Step (d) may further include newly adding important itemsets that are not managed at the Bk−1 among the itemsets of the Uk to the second layer prefix tree.

The method for finding frequent itemsets may further include finding the frequent itemsets that circulates the second layer prefix tree by a depth-first finding method and extracts nodes each of which the support is a predetermined minimum support or more.

The finding of the frequent itemsets may find the frequent itemsets, including the itemsets of the first layer prefix tree.

The finding of the frequent itemsets at the second layer prefix tree may find the frequent itemsets, having the minimum support equal to or lower than the finding of the frequent itemsets at the first layer prefix tree.

The method for finding frequent itemsets may further include estimating the appearance frequency of any item that can be generated by the nodes having the compressed itemsets as the item when ω>0.

The estimating of the appearance frequency of any item may be performed by using the value of the appearance frequency of the compressed itemsets as the appearance frequency of any item.

In order to solve the technical problems, the present disclosure provides a computer-readable recording medium recording programs for executing the method for finding the frequent itemsets from the data streams.

As set forth above, the method for finding frequent itemsets according to the exemplary embodiment of the present invention can effectively find the frequent itemsets in the long transaction data stream environment.

### BRIEF DESCRIPTION OF THE DRAWINGS

FIG. 1A shows an example of a β-layer prefix tree;

FIG. 1B shows a structure where the β-layer prefix tree of FIG. 1A is reconfigured of a general prefix tree;

FIG. 2 is a conceptual diagram showing an entire configuration of a PET method;

FIG. 3 shows an example of a PET method;

FIG. 4 is an example of generating compressed itemsets for frequent itemsets;

FIG. 5 is an algorithm showing a process of generating compressed itemsets at Pm.k;

FIG. 6 shows an example of a merge;

FIG. 7 shows a portion of merge result tuples shown in FIG. 6-(B) as an example of sub-transactions;

FIG. 8 shows a process of generating and managing a β-layer prefix tree; and

FIG. 9 shows an example of a recovery of ω-compression.

### DETAILED DESCRIPTION

Hereinafter, exemplary embodiments of the present invention will be described in detail with reference to the accompanying drawings. In this description, when any one element is connected to another element, the corresponding element may be connected directly to another element or with a third element interposed therebetween. First of all, it is to be noted that in giving reference numerals to elements of each drawing, like reference numerals refer to like elements even though like elements are shown in different drawings. The components and operations of the present invention illustrated in the drawings and described with reference to the drawings are described as at least one exemplary embodiment and the spirit and the core components and operation of the present invention are not limited thereto.

Hereinafter, a method for finding frequent itemsets according to an exemplary embodiment of the present invention is referred to as a Projection, mErge and mining sTructure (PET) method. The PET method is a mining method that includes an α-layer configured of an α-prefix tree, a merge operation, and a β-layer configured of a β-prefix tree. Unlike the existing mining methods of forming one prefix tree for one data stream, the PET method mines tuples at the β-layer by projecting one data stream into several data streams to find frequent itemsets using each of a plurality of α-prefix trees and merging the frequent itemsets of each prefix tree in order to manage the itemsets projected when projecting the data streams. During the process, when each α-layer prefix tree of the α-layer generates the frequent itemsets for the merge operation, if a difference in support between one frequent itemset and other frequent itemsets is in a compression threshold ω that is previously defined, the PET method merges the corresponding frequent itemsets in order to manage them as one compressed itemset, such that it can reduce the amount of the frequent itemsets when too many frequent itemsets are generated, thereby reducing the burden on usage and run time of a memory.

The β-layer estimates the support using single appearance frequency and the compression threshold ω while managing the plurality of itemsets at a single node. At the β-layer, the number of nodes is changed by the compression threshold ω but as the ω value is large, a large number of itemsets are represented by a single node, such that the accuracy of the size of the β-layer and the mining results is reduced. However, the accuracy of finding the frequent itemsets of the β-layer may be controlled using a minimum support lower bound threshold ε. Through the method, the exemplary embodiment of the present invention remarkably reduces the memory usage while obtaining all the advantages of lossless compression and lossy approximation that are a compression method, thereby making it possible to find the frequent itemsets under the long transaction data stream environment.

The configuration of the present specification is as follows. Chapter 1 describes investigation and review of existing researches into a method for fining and managing compression of frequent itemsets in data streams. Chapter 2 describes in detail an α-layer, an merge operation, and a β-layer that are components of a PET method and ω-compression method and a recovery method Chapter 3 describes conclusion

Chapter 1 Relevant Researches

1.1 Method For Finding Frequent Itemsets

In the finite transaction set, as a representative algorithm of finding the frequent itemsets an Apriori algorithm[2] was proposed. The Apriori algorithm generates candidate sets n times and finds transaction information n+1 times in order to find the frequent itemsets having n length, such that the memory usage is very increased and the finding time is very long.

A Carma algorithm[16] searches transactions in a data set by using a two processing process to find the frequent itemsets. An algorithm of finding frequent itemsets targeting a fixed data set should be defined before an analysis object is subjected to a mining step and needs a scan once or more, such that it is inappropriate as a mining method of data streams.

In the environment where the data set is gradually increased, synthetic mining results for newly updated data sets may be obtained using the gradual mining algorithm such as a FUP-based algorithm[7, 8], a BORDERS algorithm[3], a DAEMON algorithm[11], etc.

The gradual mining algorithm may use the previous transaction information in order to obtain the latest results, but should store all the pieces of each transaction information and may find the previous transactions in order to accurately calculate the support, such that it is inappropriate as a method for data streams.

A Lossy Counting algorithm[21] finds the frequent itemsets by limiting the memory usage to a predetermined range during the process of fining frequent itemsets. However, this algorithm should uses the increased memory space with the increased efficiency, which has an effect on the increase of the mining run time. Similarly, an FP-stream algorithm[12] has a structure of storing all the frequent items in order to find the frequent itemsets, such that it may require a considerably large space and time according to the characteristics of the data sets.

In an on-line data stream environment, an estDec method[5] that has been researched in the past was proposed in order to efficiently find the frequent itemsets. The estDec method processes the transactions configuring the data streams as soon as the transactions are generated and manages the appearance frequency of the itemsets appearing in the transactions using a monitoring tree having a prefix tree structure without generating candidate sets for generating the frequent itemsets. The estDec method manages only a significant itemset that may be the frequent itemsets through a delay adding and pruning operation.

However, since the above-mentioned data stream mining algorithms have a structure of storing all the items that may be the frequent itemsets, much storage space and time may be required according to the size of the frequent itemsets and when the average length of the transactions configuring the data streams is considerably long, it s impossible to perform the mining.

1.2 Method of Managing Compression of Frequent Itemset

As a representative algorithm of lossless compression finding a closed frequent itemset (CFI), there are a MOMENT algorithm[9] and a CFI-stream algorithm[17]. The MOMENT algorithm finds the CFI in a data stream sliding window using a data structure referred to as a closed enumeration tree (CET). The MOMENT algorithm maintains the CFI while projecting a node into four cases such as infrequent gateway nodes, unpromising gateway nodes, intermediate nodes, and closed nodes and managing the node. Since there are a case that is not the CFI and a case that maintains even non-frequent itemsets, the MOMENT algorithm consumes a large amount of memory and consumes much time to determine what type the node is every time the transactions are generated.

The CFI-stream algorithm manages all the CFIs on the data streams using a data structure referred to as Direct Update (DIU). Due to these characteristics, the CFI-stream algorithm consumes the almost similar usage and run time of the memory regardless of the minimum support. Therefore, there may lead to an inefficient case at the relatively higher minimum support, as compared with the existing other researches.

As the lossy approximation of fining the maximum frequent itemsets (MFI), there are an MAFIA algorithm[4] and an estMax algorithm[24]. The MAFIA algorithm circulates a partial set lattice of itemsets as a depth-first method and performs search space pruning using a PEP method, an FHUT method, and an HUTMFI method. Through this, the MAFIA algorithm is more rapidly operated than the existing methods of finding other MFIs, but is not an algorithm for the data stream environment.

Since the estMax algorithm is the data stream environment, but is based on the estDec method, all the itemsets having high possibility of frequent items are maintained at the prefix tree. Therefore, since the estMax algorithm has the same memory usage as the estDec method, it has limitations such as the estDec method on the long transaction data stream.

The CP-Summary[1], which is a method of compressing profile sets after finding the frequent itemsets, configures a conditional-profile (c-profile) to compress the frequent itemsets that are an x-compressible relationship. However, since these methods just compress and exhibit many frequent itemsets, it is impossible to find the frequent itemsets at the long transaction.

A Dif-Tid algorithm[20] and a CT-Mine algorithm[13] does not correspond to a case that compresses the frequent itemsets but a case that performs compression in order to reduce the memory amount used to find the frequent itemsets. However, the Dif-Tid algorithm largely reduces the memory usage by using a process of converting itemsets into bits but performs a scan several times, which is not suitable for the data stream environment. When there are the same node patterns on the prefix trees, the CT-Mine algorithm, which is a method of uniting the node patterns into one and managing the node patterns, maintains the sub-tree structure for the longest itemsets. As a result, when an average length of the transaction is T, if the prefix tree has the number of nodes of maximum 2^{T}, the CT-Mine has the nodes of maximum 2^{T-1}. Therefore, the Dif-Tid algorithm has a limitation in performing the mining under the long transaction environment and also requires the scan several times, which is not suitable for the data stream environment.

RPglobal and RPlocal that are a method for fining frequent itemsets for a limited data set have been introduced into [25]. When there are p and p′ that are two itemsets, if the similarity between two itemsets while p is a subset of p′ is a predetermined δ(0≦δ≦1) or less, p is referred to as δ-covered and a set p of the itemset is referred to as δ-cluster. The RPglobal and RPlocal find only the frequent itemsets that may represent all the frequent itemsets, instead of finding all the frequent itemsets. The RPglobal has excellent compression rate and high calculation complexity and the RPlocal has degraded compression efficiency but is more efficiently operated. The number of representative frequent itemsets may be controlled by controlling a δ value. The two methods require a data set scan several times, which are not suitable for the data streams.

CP-tree[19] proposed a method for reducing the memory usage through the inter-node merging when the support of a node and another node is within δ, having a merging threshold value δ(0≦δ≦1) therebetween, based on the estDec method performing the mining under the data stream environment, in order to supplement the limitations. However, the CP-tree does not largely change the memory usage as the number of items to be managed is not largely changed even though the inter-node merging is generated and increases the burden of the run time during the projection and merging of the nodes, thereby very degrading the speed.

Chapter 2 PET Method

Chapter 2 describes in detail terminologies for the basic stream data mining for describing a projection, mErge and mining sTructure (PET) method that is a method proposed in the exemplary embodiment of the present invention and the operation and configuration of the PET method.

The PET method performs the mining by projecting one transaction into several α-layer prefix trees, such that it has information that is not maintained. Therefore, the PET method requires the merging step in order to maintain the information. However, in order to reduce the burden at the time of the merging and the burden of the memory usage at the β-layer, the exemplary embodiment of the present invention proposes a ω-compression method. Chapter 2 describes the method and a method for recovering ω-compression and a method for minimizing errors in support.

2. 1 Dictionary Definition

The data streams for mining the frequent itemsets, which are an infinite set of the transaction that is continuously generated, are defined as follows.

i) I={i₁, i₂, . . . , iₙ} is a set of items until now, wherein the item implies the unit information generated in the application domain.

ii) When 2^{I} represents a power set of the set I, e satisfying eε(eε2^{I}−{ø}) is referred to as an itemset, a length |e| of the itemset implies the number of items configuring the itemset e, and any itemset e is defined as |e|-itemset according to the length of the corresponding itemset. Generally, 3-itemset is simply represented by abc.

iii) the transaction is a subset of I, not a null set and each transaction has a transaction identifier TID. The transaction added to the data set in an k-th order is represented by Tk and the TID of Tk is k.

iv) when the new transaction Tk is added, the current data set Dk is configured of all the transactions that are generated and added until now, that is, Dk=<T1, T2, . . . , Tk>.

Therefore, |Dk| implies a total number of transactions included in the current data set Dk. When Tk is referred to as a current transaction, the current appearance frequency for any itemset e is defined as Ck(e), which represents the number of transactions including e from the k transaction until now. Similarly, the current support Sk(e) of the itemset e is defined as a ratio of appearance frequency Ck(e) of the itemset e to the total number of transactions |Dk| until now. When the current support Sk(e) of the itemset e is the previously defined minimum support Smin or more, the itemset e is defined as the frequent itemsets at the current data stream Dk.

2. 2 Configuration of PET Method

In order to supplement the demerits of the prefix tree and the CP-tree according to the estDec method described in the relevant research, the exemplary embodiment of the present invention proposes the PET method that is a new method for finding frequent itemsets. The previous researches allow a single prefix tree to manage the itemsets of the single data stream. On the other hand, the PET method projects the single data stream into m data streams and manages them using m α-layer prefix trees. In this case, when projecting the data streams, the PET method does not maintain the appearance frequencies of the projected itemsets, such that it compresses and merges the frequent itemsets generated for Tk at m prefix trees according to the compression threshold value ω and then, manages the merged tuple results at the β-layer prefix tree that is another tree structure. The mining structure is defined as follows.

Definition 1 α-Layer (an Alpha Layer)

The α-layer is configured of m prefix trees that may find the frequent itemsets and has several independent α-prefix trees and a relationship of 1:N. In the case where an m-th α-layer prefix tree reflecting the transaction Tk generated when the TID is k is Pm.K, the α-layer is represented as follows.

α={P_{1.k}, P_{2.k}, . . . , P_{m.k}}(m≧2).

The case where the specific position of the α-layer prefix tree is not specified is referred to as Pk.

Definition 2. β-layer (a Beta-Layer)

In the case where the new transaction Tk generated when the TID is k is generated, the β-layer Bk that is a tree structure is represented as follows.

1. 1. The β-layer Bk has a single route node having a “null” value, each node other than the route node has items that are and when i₁, i₂, . . . , iₖ and when e=i₁i₂ . . . iₖ(e=i₁i₂ . . . iₖ^{εI}), has the timesets corresponding to e.

2. For the itemset e=the item i₁i₂ . . . iₖ, the item i₁, i₂, . . . , iₖ is arranged in a dictionary order and when the nodes existing on the path from the route node to any node n are formed in order nᵣₒₒₜ→n₁→n₂→ . . . →nᵥ→n, and any node nⱼ on the path has the itemset eₖ, the node n represents itemset eₙ=e₁e₂ . . . eᵥeₖ to manage the current appearance frequency C_{K}(eₙ) of eₙ.

3. Each node is configured of four fields as follows: the itemset e, the appearance frequency Ck(e) of the itemset, a link connecting child nodes of each node, and the updated TID.

The exemplary embodiment of the present invention is progressed under the assumption that the prefix tree capable of finding the frequent itemsets described in Definition 1 is a prefix tree managed by the estDec method. When the conditions according to the characteristics of each algorithm are established, the frequent itemset algorithm of a static data set such as the FP-tree[15] as well as the algorithm of finding frequent itemsets in the real-time data stream environment such as SWIM[22] or [6] may be positioned.

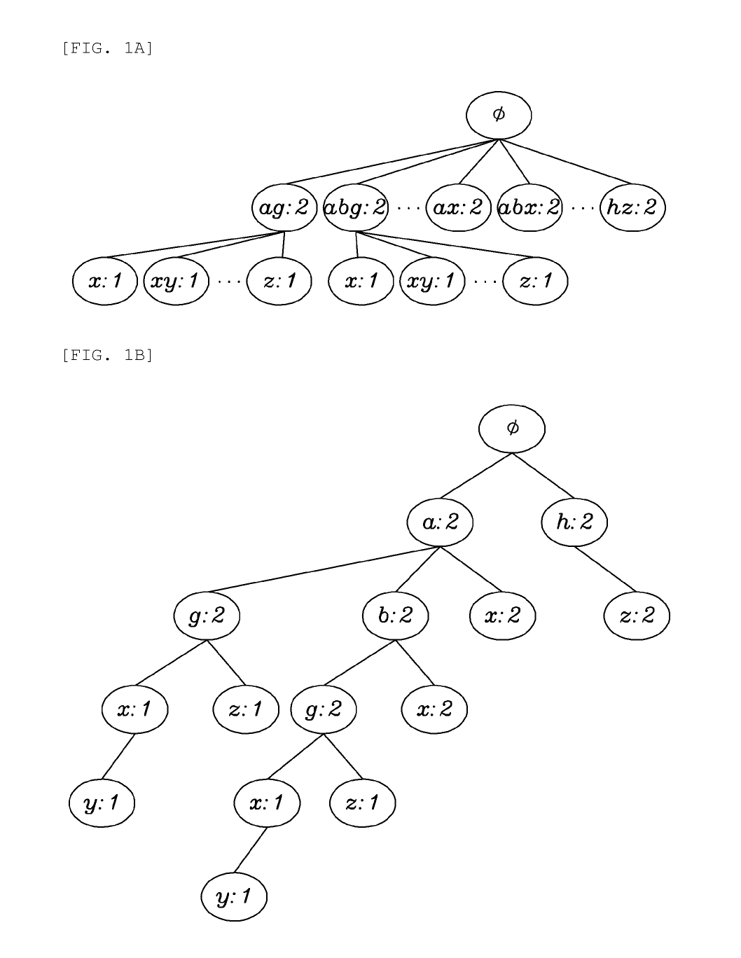

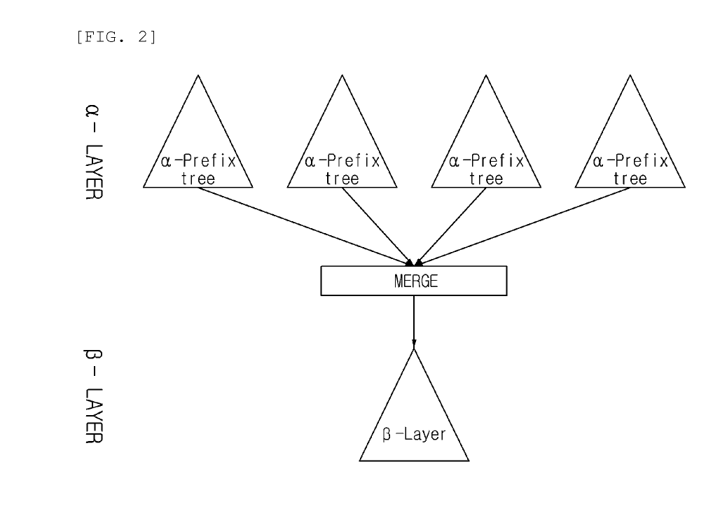

FIG. 1A is an example of the β-layer prefix tree, which has the same structure of FIG. 1B when the structure is represented as a general prefix tree. As the β-layer structure as shown in FIG. 1A can obtain an effect of combining more than two levels into a single node, it can be appreciated that the number of nodes is reduced and as a result, the memory usage is reduced.

Definition 3. Projected Transactions

For the transaction Tk generated when the TID is k, the projected transaction is generated as many as the number of maximum α-layer prefix trees by projecting the Tk at the α-layer. The projected transaction Tm.k generated at the m-th α-layer prefix tree may be represented as follows.

Tₖ={T_{1.k}∪T_{2.k}∪ . . . ∪T_{m.k}}

(however, m≧2 and T1.k∩T2.k∩ . . . ∩Tm.k=Ø)

The PET method, which has the mining structure of finding the frequent itemsets configured of several β-layers, the merge with the α-layer, projects the Tk into |α| projection transaction Tm.k at the α-layer in the case where there is the transaction Tk generated when the TID is k and mines the Tm.k at each α-layer prefix tree Pm.k. In this case, when there is the frequent itemsets coinciding with the power set of the Tm.k with the Pm.k, the PET method merges these frequent itemsets through the merge step. The merged result tuples are subjected to the process of finding the frequent itemsets at the β-layer and then, the process of fining the frequent itemsets for Tk at the β-layer ends. The frequent itemsets after being subjected to the above-mentioned processes combine the results searched at all the prefix trees of all the layers.

FIG. 2 is a conceptual diagram showing an entire configuration of the PET method.

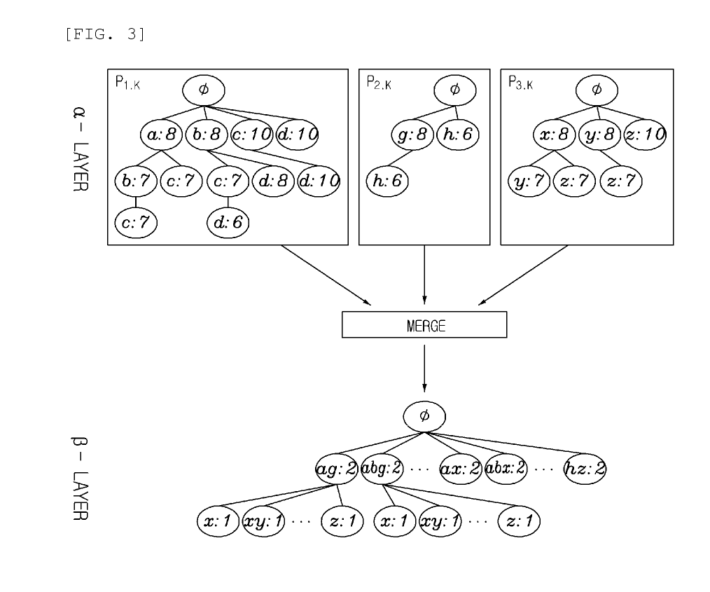

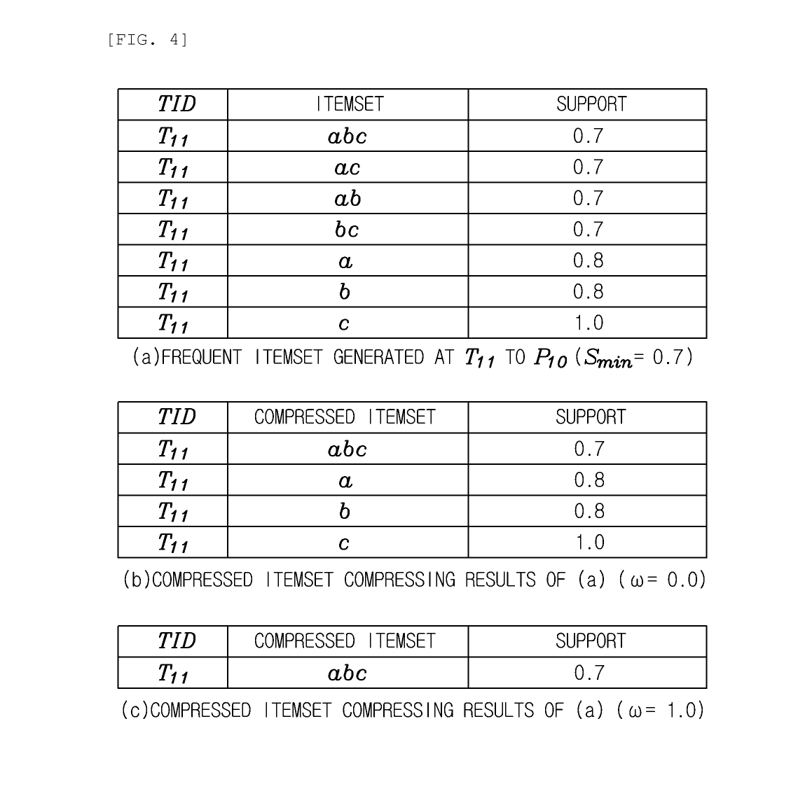

FIG. 3 is an example of the PET method, which is configured as three α-layer prefix tree Pk, wherein each α-layer prefix tree processes Dk that is projected independently. In addition, there may be appreciated that the merge step is present between the α-layer and the β-layer. When the transaction Tk referred to as abcqhxyz is generated, the Tk is projected into T1.k:abc, T2.k:gh T3. k:xyz to be mined at each of the prefix trees P1.k, P2.k. and P3.k, such that the appearance frequency for the projected transaction may be managed, but the appearance frequency of some itemsets such as ag and abx cannot be managed during the projection process due to the projection of items. Therefore, as a result of merging the itemsets projected during the merge step performing the merge, the PET method intends to manage all the frequent itemsets using the tuple as the mining input of the β-layer.

2.2 ω-Compression Method

As described above, a need exists for the merge because it is impossible to manage the itemsets projected by the projection transaction Tm.k mined at the m-th α-layer prefix tree Pm.k of the α-layer and the m−1-th projection transaction Tm−1.k mined at the Pm−1.k. When the itemsets corresponding to the power set other than the null set of the m-th transaction Tm.k correspond to the frequent itemsets managed at the Pm.k−1, they are a target of the merge. In this case, since the maximum number of frequent itemsets for the Tm.k is equal to the number of elements of the power set other than the null set of the Tm.k, if |α| represents the number of α-layer prefix trees, the number of frequent itemsets is increased in proportion to a square of |α| as the |α| is increased, which is greatly burdened to the usage and run time of the memory during the merge and the mining process of the β-layer. Therefore, it is to reduce the above-mentioned burden by compressing the frequent itemsets generated at each of the α-layer prefix tree Pk.

The ω-compression that is the compression method proposed in the exemplary embodiment of the present invention is a method that does not reflect a subset y considering only a superset x as the meaningful itemsets when the frequent itemsets x and y generated at the Pk for the single transaction Tk have the subset relationship with the superset and the difference in support is ω(0≦ω≦1).

Definition 4. Compressed Itemsets

As to the previously defined compression threshold ω, if the frequent itemsets generated when the new transaction Tk is generated are referred to as x, the x satisfying the following conditions is defined as the compressed itemsets (CI).

|Ck(x)−Ck(y)|/|Dk|≦ω (however, y⊂x)

FIG. 4 is an example of generating the compressed itemsets for the frequent itemsets obtained by generating T11.abc when the Smin is 0.7 and ω is 0.0 and 1.0 at the example of FIG. 3. When FIG. 4A is the frequent itemsets to be compressed, FIG. 4B is the compressed itemsets obtained when ω is 0.0, and abc, ab, bc, and ac have the support of 0.7 and the ω difference is 0, such that they are compressed as the superset abc. In addition, b and c, which are the support of 0.8, do not have the subset relationship even though the ω difference is 0 and are not compressed. FIG. 4C is the compressed item obtained when ω is 1.0 and only the abc remains as the compressed itemsets since the frequent itemsets of abc may include all the other frequent itemsets.

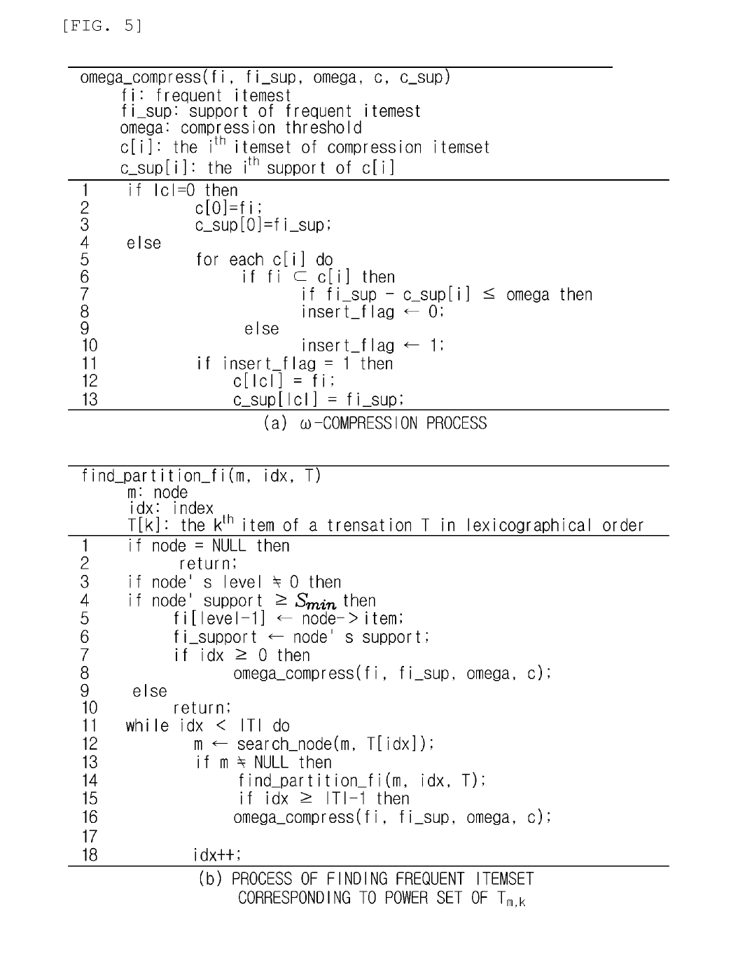

The ω-compression is the most primitive method that outputs all the frequent itemsets and then, aligns them in order of small support to perform the compression while comparing with the subsequent item. The reason why an order of the support is important is that the support representing the compressed itemsets is low if the itemsets are subjected to compression once when they are compared with the subsequent item in order of large support and the items are compared with the subsequent item at the low support, such that even the itemsets that should not be compressed may be consecutively compressed. Therefore, when the itemsets are compressed in order of small support from the beginning, the support to be compared is large such that the errors occurring due to the consecutive compression may be removed. However, when using the method, since the alignment cost and the comparison cost are exponentially increased with the increase in |Tk|, the method may be used by correcting the depth-first finding method like the algorithm of FIG. 5.

Definition 5. Producability

When the TID is k, if the projected transaction Tm.k is reflected to the prefix tree Pm.k−1, the TID is a ratio of the number of Tm.k and the number of compressed itemsets where the itemset corresponding to the power set other than the null set of the Tm.k in the node of Pm.k−1 is Smin or more may be represented as follows when |CIm.k| is the number of compressed itemsets generated when the TID is k. producability(Tm.k)=|CIm.k|

When this is applied to the m-th projection data stream Dm.k, this is as follows.

producability(Dm.k)=(|CIm.1|+|CIm.2|+ . . . +|CIm.k|/|Dm.k|

When the permitted error is the compression threshold value ω, the producability may be reduced by compressing the frequent itemsets generated at each Pm.k for ω. The reduction in producability implies the reduction in the run time of the merge and the number of tuples generated during the merge, which directly affects the reduction in the usage and run-time of the memory at the β-layer. In this case, since the producability (Tm.k) for one Tk has the value of the maximum 2t−1 (t=|Tm.k|), the maximum number of tuples after the merging may be estimated as x|α| (x=(producability(T1.k)+producability(T2.k)+ . . . +producability(T|α|.k))/|α|) and causes the large burden at the β-layer using the tuple after being merged according to the increase in |Tk| as the input value and largely increases the time of the merge.

It can be seen through FIG. 4 that the producability is low as ω is large. In addition, when ω is largely set to approach 1.0, all the elements of CIK may be compressed as only a single compressed itemsets. In this case, the minimum producability is that producability(Tm.k)=1 and Producability(Dm.k)=|Dm.k|.

2.3 Merge

When the number of prefix trees belonging to the layer just before the merge step is m, the merge between the compressed itemsets CIk generated at the m prefix tress by the transaction Tk generated when the TID is k during the merge step that is the subsequent step is performed. Since the merge merges the m CIK at a time as well as merges the CIk groups of a smaller number than m, the merge is performed by inserting empty items in each CIk. This is for previously generating all the subsets at the merge since circulating all the subsets of the merge result tuples at the time of updating the appearance frequency at the β-layer affects the increase in run time. Therefore, the method of updating the appearance frequency at the β-layer is operated differently from the existing estDec method or the CP-tree method and will be described in detail below.

The merge is performed in a type concatenating CI1.k to Cim.k generated at first to m-th prefix tree between the compressed itemsets such as TID. Therefore, when m is 3, if the number of CI1.k is 5, the number of CI2.k is 2, and the number of CI3. k is 5, the merge result tuple having the TID such as 5 *2 *5=50 is generated.

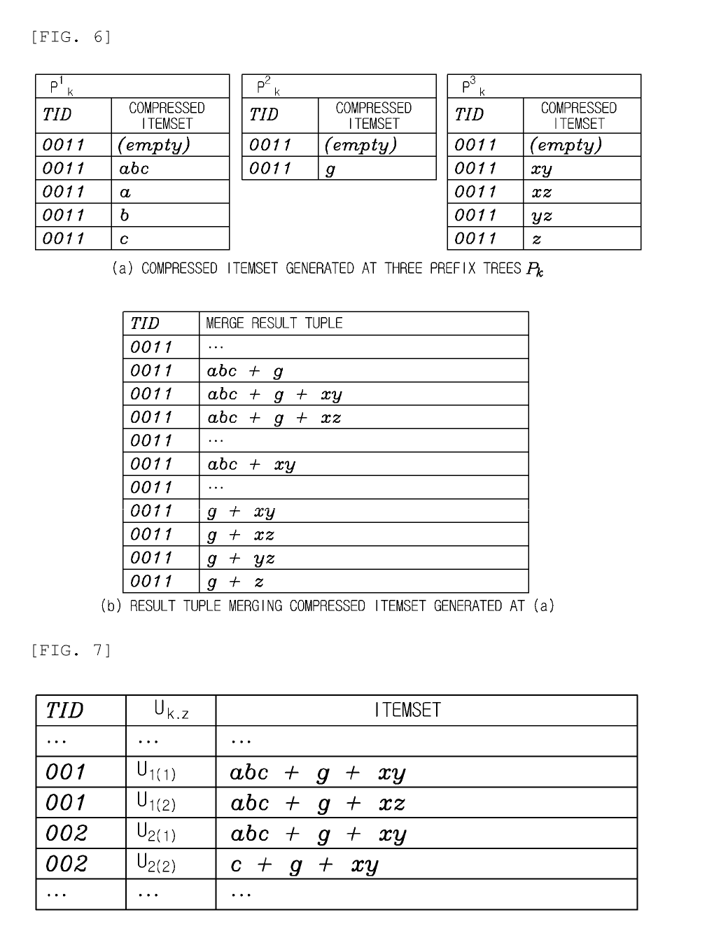

FIG. 6A shows the compressed itemsets of the frequent itemsets generated at each prefix tree when |α| is 3. When performing the merge on three compressed itemsets, (empty) is first selected at p1.k, (empty) is selected at P2.k, and (empty) is selected at P3.k, such that (empty) results are generated. Thereafter, all the P3.k such as (empty)+(empty)+xy, (empty)+(empty)+xz, . . . , is scanned and then, return to P2.k to perform the scan such as (empty)+g+(empty), (empty)+g+xy, (empty)+g+xz and merge them. FIG. 6B shows the results of performing a recursive merge. The result tuple includes a discriminator ‘+’, which can divide the compressed itemsets generated at different prefix trees in order to update and manage the node at the β-layer.

2.4 Frequent Item Finding Using β-Layer Prefix Tree

The β-layer is operated in a method designed by improving the existing estDec method and is configured based on the estDec method, but the data structure uses the β-layer, not using the existing prefix tree in order to manage the important itemsets.

The estDec method differently maintains weight of information with the passage of time by applying an attenuation factor, such that the recent frequent itemsets can be searched. The exemplary embodiment of the present invention will omit the detailed description of the method of applying an attenuation factor in order to mainly describe a mining method using the β-layer. However, the method of using the β-layer such as the estDec method using the prefix tree can also search the recent frequent itemsets by applying the attenuation factor. In addition, it performs the delay addition and pruning process such as the estDec method, but has a slight difference in view of the characteristics of the β-layer.

Definition 6. Sub-Transactions

As the tuples of the merge results for Tk, the tuples applied to the β-layer prefix tree are referred to as sub-transactions Uk. Therefore, the plurality of sub-transactions Uk have all the same k as the TID and are represented as follows.

Uₖ{Uₖ₍₁₎, Uₖ₍₂₎, . . . , Uₖ₍ᵢ₎}

Similar to the estDec method, the management of the β-layer includes four steps, that is, a parameter updating step, an appearance frequency and node updating step, an itemset adding step, and a force pruning step. When the new sub-transactions Uk is generated at the data stream Dk−1, two steps other than the parameter updating step and the force pruning step are sequentially performed and the parameter updating step is performed each time when the TID of the sub-transactions is changed and the force pruning step is periodically performed according the user request. Each step will be described as follows.

First step) Parameter Update: The number of all transactions of the data stream Dk is updated. Since the plurality of sub-transactions are generated at a single transaction, the number of transactions is not updated whenever the sub-transactions are generated and when the TID of the sub-transactions is changed, that is, the TID of the real transactions, not the TID of the sub-transactions, is changed, the number of transactions is updated.

Second Step) Appearance Frequency and Node Update: This step is performed while finding Bk−1 by a dictionary order of items of a new sub-transaction Uk. In this case, all subsets Bk−1 of the sub-transactions are not found by the depth-first finding method, the Bk−1 is found by adding the items corresponding to two α-layer prefix trees in front of the sub-transactions, while keeping the items as they are. The reason is that a 1-level node of the β-layer has as an item the itemsets in a type where the compressed itemsets CIa.k and CIb.k generated at two prefix trees Pa.k and Pb.k configuring the α-layer are concatenated and more than 2-level node has as an item the compressed itemset CIc.k generated at a single prefix tree Pc.k configuring the α-layer. For searched each node of Bk−1, the second step increases the appearance frequency and stores the current TID in order not to be affected by the subsequent sub-transactions input, having the same TID.

Third Step) Itemset Addition: The step of adding itemsets newly adds the important itemsets that are not managed at Bk−1 among the itemsets of the sub-transaction Uk to the monitoring tree. The β prefix tree reflects only the frequent items having the support of Smin or more at the prefix tree Pk of α, such that the filtering step may be omitted. Similar to the estDec method, the node m of Bk representing each important n-itemset e=i₁i₂ . . . iₙ (n≧3) searches for the frequent itemset e′ generated at (n+1) α-layer prefix tress that is e ∪ in +1εUk and at the same time, checks whether the frequent itemsets generated at all the n α-layer prefix trees of e′ are managed at Bk−1. When satisfying all the conditions, appearance frequency C(e′) of the new important itemsets e′ is estimated by the estimation method described in the estDec method and when C(e′)≧Ssig, a new node w to represent e′ is inserted into Bk.

Fourth Step) Force Pruning Step: As described above, since the β-layer generates the sub-transactions configured of the frequent itemsets where the support at Pk of a is Smin or more, the node that is Ssig or less may approach the update process, such that the unnecessary node should be removed by periodically performing the force pruning.

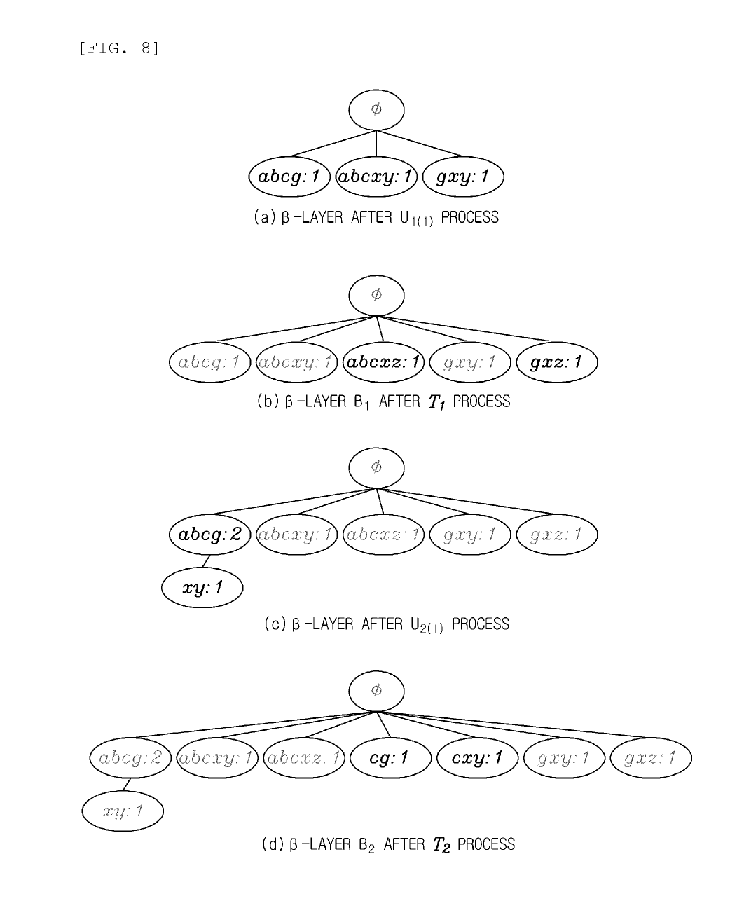

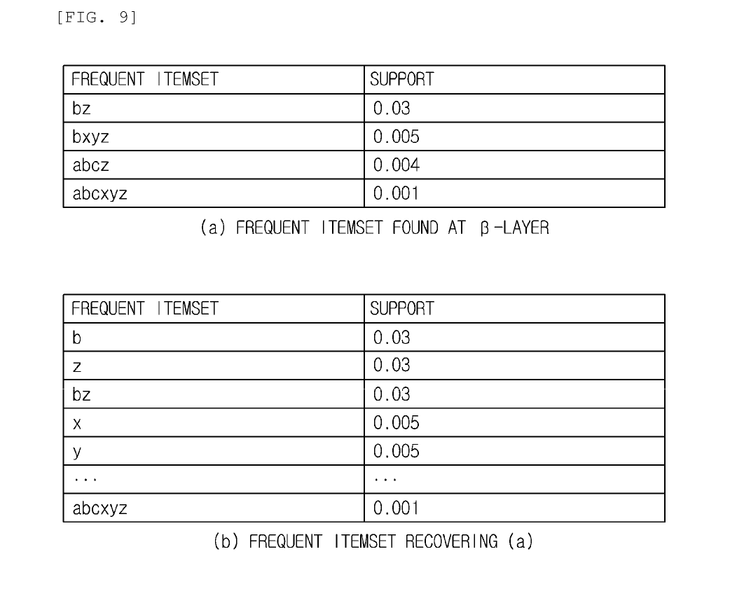

FIG. 7 is a portion of the merge result tuples shown in FIG. 6B and FIG. 8 shows a process of generating and managing the β-layer when the transaction is equal to FIG. 7. The β-layer B1 of FIG. 8A is configured by the U1(1) of FIG. 7. When the sub-transaction Uk is generated at the β-layer, since it can be determined whether each item is generated at any α-layer prefix tree Pk, a type of concatenating two compressed itemsets generated at two Pks is inserted into the first level item, as definition 4. Since an example is 3 Pks, the generable items are 3 (=3C2) of abcg, abcxy, and gxy. When the subsequent sub-transaction U1(2) is generated, although the node corresponding to abcg merging the compressed itemsets of the first two Pks at the time of finding the trees in order to first update the appearance frequency is searched, since the updated TID is equal to the current TID, the update of the appearance frequency is not generated. Then, FIG. 8B shows a shape of adding abcxz and gxz during the step of adding the itemsets. FIG. 8C shows that the TID is changed and then U2(1) is processed. First, as described above, since the update of the appearance frequency first finds the itemsets configured of the first two α-layer prefix trees, the appearance frequency is updated by finding abcg. Thereafter, since the insertion process is similarly performed to the estDec method, after searching whether the itemsets abcg, gxy, and abcxy configured of a portion Pk of abcgxy is in the Bk, the frequency of the newly generated node w during the initialization process of the smallest appearance frequency is estimated and is inserted. The update and insertion are repeated by this method, such that the tree B2 processing all the transactions of FIG. 7 is the same as FIG. 8D.

The search of the frequent itemsets depends on the method of circulating the tree Bk in the depth-first finding method like the estDec method and extracting the itemsets where the support of each node is Smin or more. Since Bk has a structure of managing only the itemsets concatenating between each α-layer prefix tree, it should include the frequent itemsets of all the α-layer prefix trees Pk in order to find all the itemsets.

When the ω compression becomes ω>0.0 at the α-layer, the frequent item e° belonging to P1.k is summed with the compressed itemsets e by the ω-compression, such that the case where the itemsets of e+b obtained by being merged with the frequent itemsets b of another Pm/k has the support smaller than the minimum support at the β-layer may be generated. That is, when the compression is not performed as the case such as Sk(e°+b)>Smin>Sk(e+b), the search is made as the frequent itemsets but when the frequent itemsets are not formed due to the performance of the compression, the false negative cannot help being generated. For the problems, the finding may be performed at a value slightly lower than the minimum support of Smin−ω*ε (0≦ε≦1.0) according to the characteristics of the data stream at the time of finding the frequent item of the β-layer. The false negative is reduced but the false positive is increased, according to the increase in ε. The optimal value of ε may be set according to each data stream, in consideration of these characteristics.

2.5 ω-Compression Recovery Method

Since the PET method compresses and manages the appearance frequency using the compression threshold value ω, it may accurately compress and manage the appearance frequency only when the compression is not performed, i.e., only when ω=−1 and ω=0.0. Therefore, when ω>0.0, the appearance frequency generated through the appearance frequency of the compressed itemsets should be estimated. When the node m including the compressed itemsets e° as the item is provided, the appearance frequency Ck(e) of any item e that can be generated by m may be estimated by simply using the value of the Ck(e°). Since the compression for ω is already performed at α, even in this case, the maximum error of the support does not exceed ω, which is verified as follows.

Summary 1. Maximum Error according to Estimation of Appearance Frequency

For item a°+b of any node m of the β prefix tree and any item a+b generated by m, when the real support of a+b is Sk(a+b) and the estimation support of the corresponding item a+b is Sk(a°+b), the maximum error according to the appearance frequency estimation of e satisfies |Sk(a+b)−Sk(a°+b)|≦ω at all times. (Verification) when the item of m is a°+b that is a combined type of a° formed by compressing item a generated at different prefix trees Pa.k and Pb.k and b, Skmax (a+b) may be represented as follows by the Apriori characteristics.

Skmax(a+b)=min(Sk(a),Sk(b))

When the support of a°+b is represented as follow,

Skmax(a°+b)=)min(Sk(a°,Sk(b))

Since Sk(a)−Sk(a°)≦ω, it may represented as follows.

Skmax(a°+b)=min(Sk(a)−ω,Sk(b))

Skmax(a+b)−Skmax(a°+b)=min(Sk(a),Sk(b))−min(Sk(a)−ω,Sk(b)).

since Sk(a°)≦Sk(a), the verification is established by comparing the inequality with Sk(b).

when Sk(a°)≦Sk(a)≦Sk(b), since Sk(a)−ω≦Sk(a),Skmax(a+b)−Skmax(a°+b)=Sk((a)−Sk((a)+ω=ω (1)

when Sk(b)≦Sk(a°)≦Sk(a),Skmax(a+b)−Skmax(a°+b)=Sk(b)−Sk(b)=0 (2)

when Sk(a°)≦Sk(b)≦Sk(a), since Sk(a)−ω≦Sk(b)≦Sk(a),Skmax(a+b)−Skmax(a°+b)=Sk(b)−Sk(a)+ω≦ω

Therefore, the maximum support error of Skmax(a+b)−Skmax(a°+b) is ω, |Sk(a+b)−Sk(a°+b)|≦ω is established.

FIG. 9 shows the recovery method performed according to the above estimation method. As the ω value becomes large, since more nodes are compressed and managed, the memory usage of the β-layer is reduced but the estimation error generated during the process of estimating the appearance frequency of the itemsets is increased.

When the remaining items are estimated at the above compressed frequent itemsets, it should be necessarily performed in order of large support. When there are one item and a subset of the item due to Antimonotone characteristics, since the support of the subset is large or equal at all times, there is no case that is out of the Antimonotone characteristics when being performed in order of support. On the other hand, when the subset is generated in order of small support, the shortest item may have the smallest support and the second short item may have the larger support, such that they are out of the Antimonotone characteristics.

Although the frequent itemsets can be estimated within the maximum error range by the method shown in FIG. 9, the error of the support of the frequent itemsets obtained when the maximum error of the support is large cannot but increase. Therefore, the support of the estimated frequent itemsets may be more precisely estimated than the maximum error range by using the maximum error range and the support of the compressed frequent itemsets. When the support of the node m of the compressed frequent itemsets is Sk(m), the current support Sk(ei) of the frequent itemsets ei estimated by the m may be obtained as follows.

When f(m, ω) is a support estimation function estimating the support Sk(ei) of ei based on the support Sk(m) of m and the maximum error range ω, the support of ei may be estimated by Sk(ei)=Sk(m)+f(m, ω). In this case, the estimation function f(m, ω) may be defined in several types, meeting the characteristics of the data set. The exemplary embodiment of the present invention defines the following estimation function. It is assumed that the increase in the appearance frequency due to the reduction in the length of the item is increased as the length of the item is reduced. In this case, the estimation function is defined as f(m, ω) and the appearance frequency may not be larger than Sk(m)+ω.

f(m,ω)={ω(|m|²−|eᵢ|²)}/(|m|²−1)

Example 1. when the itemset ei managed by any node m of the β prefix tree is abcd, the support is 0.3, and ω is 0.1, the frequent itemset ab may be estimated as follows.

$$\begin{matrix}Sk ( e ) = Sk ( m ) + f ( m , ω ) \\ = Sk ( m ) + f ( m , ω ) \\ = {Sk}^{\{ ω ( {\vert m \vert}^{2} - {\vert {e}_{i} \vert}^{2} ) \}} ( m ) + / ( \vert m \vert 2 - 1 ) \} \\ = 0.3 + \{ 0.1 * ( 16 - 4 ) \} / 15 \\ = 0.3 + 0.08 \\ = 0.38\end{matrix}$$

Due to the process of estimating the support of the itemset, the support of the itemset managed at the β-layer includes the estimation error and the range of the estimation error is affected by the compression threshold value ω. Therefore, as ω becomes large, the use of the above-mentioned support estimation function may be effective and the optimal support estimation function may exist according to the characteristics of the data stream.

Chapter 3. Conclusion

In order to find the frequent itemsets on the infinite data streams, it is important to efficiently manage the appearance frequency of each frequent item. In particular, it is also important to obtain the results of the frequent itemsets within a rapid time at any timing of the data stream by performing the mining at the limited memory. In order to satisfy the demands, the existing research proposed the estDec method but the method manages all the subsets of which the support is Ssig or more for the itemsets appearing in the data stream, such that much run time is consumed or the memory usage exceeds the available memory space, thereby not performing the mining. In order to supplement the disadvantage, the exemplary embodiment of the present invention proposed the PET method that is a new mining method, a structure used for the method, and a management method of the β-layer. Unlike the existing method of managing the itemsets of the single data stream with the single prefix tree, the method divides and manages the single data stream into m by using several prefix trees and manages only the lost information at the β-layer to reduce the used memory or the run time. Further, the method can obtain the results having the support error corresponding to the maximum ω while reducing the memory usage of the β-layer by using the ω-compression. The frequent itemsets can be found even in the long transaction data stream through the above-mentioned characteristics and can find the more accurate frequent itemsets than the results of the CP-tree that is the method for managing the frequent itemsets compression on the existing data stream by using the support error estimation function and the minimum support low bound value.

Meanwhile, the exemplary embodiments of the present invention may be implemented as programs executable in a computer and may be implemented in a general-purpose digital computer operating the programs using a computer-readable recording medium. The computer-readable recording medium includes a storage medium such as a magnetic storage medium (for example, ROM, a floppy disk, a hard disk, etc.), an optical reading medium (for example, CD-ROM, DVD, etc.).

As described above, the exemplary embodiments have been described and illustrated in the drawings and the specification. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

### REFERENCE DOCUMENTS

[1] Ardian Krestanto Poernomo, Vivekanand Gopalkrishnan, “CP-Summary: A Concise Representation for Browsing Frequent Itemsets”, Proceedings of the 15th ACM SIGKDD international conference on Knowledge discovery and data mining, pp. 678-696, 2009.
[2] R. Agrawal, R. Srikant, “Fast Algorithms for Mining Assoiciation Rules”, In Proceedings of the 20th International Conference on Very Large Databases, pp. 487-499, 1994.
[3] Y. Aumann, R. Feldman, O. Lipshtat, and H. Manilla. “Borders: An Efficient Algorithm for Association Generation in Dynamic Databases”, In Journal of Intelligent Information System, vol. 12, no. 1, pp. 61-73, 1999.
[4] Douglas Burdick, Manuel Calimlim, Jason Flannick, Johannes Gehrke, Tomi Yiu. “MAFIA: A Maximal Frequent Itemset Algorithm”, In Proceedings of IEEE Transactions on Knowledge and Data Engineering, vol. 17, no. 11, pp. 1490-1504, 2005.
[5] J. H. Chang and W. S. Lee. “Finding recent frequent itemsets adaptively over online data streams”, In Proceedings of the 9th ACM SIGKDD international conference on Knowledge Discovery and Data Mining, pp. 487-492, 2003.
[6] James Cheng, Yiping Ke, and Wilfred Ng, “Maintaining Frequent Itemsets over High-Speed Data Stream”, In Proceedings of the The 10th Pacific-Asia Conference on Knowledge Discovery and Data Mining, pp. 462-467, 2006.
[7] D. Cheung, J. Han, V. Ng, and C. Y. Wong. “Maintenance of Discovered Association Rules in Large Databases: An Incremental Updating Technique”, In Proceedings of the 12th International Conference on Data Engineering, pp. 106-114, 1996.
[8] D. Cheung, S. D. Lee, and B. Kao. “A general Incremental Technique for Maintaining Discovered Association Rules”, In Proceedings of the 5th International Conference on Databases Systems for Advanced Applications, pp. 185-194, 1997.
[9] Yun Chi, Haixun Wang, Philip S. Yu, Richard R. Muntz. “Moment: Maintaining Closed Frequent Itemsets over a Stream Sliding Window”, In Proceedings of the 4th IEEE International Conference on Data Mining, pp. 59-66, 2004.
[10] M. Garofalakis, J. Gehrke and R. Rastogi. “Querying and mining data streams: you only get one look”, In the tutorial notes of the 28th International Conference on Very Large Databases, 2002.
[11] V. Ganti, J. Gehrke, and R. Ramakrishnan. “DAEMON: Mining and Monitoring Evolving Data”, In Proceedings of the 16th International Conference on Data Engineering, pp. 439-448, 2000.
[12] C. Giannella et al. “Chapter 3: Mining frequent patterns in data streams at multiple time granularities. In Data Mining Next Generation Challenges and Future Directions”, AAAI/MIT Press, 2004.
[13] R. Gopalan, Y. G. Sucahyo, “Fast Frequent Itemset Mining using Compressed Data Representation”, In Proceedings of IASTED International Conference on Databases and Applications, 2003.
[14] D. Gunopulos, H. Mannila, R. Khardon, and H. Toivonen, “Data mining, hypergraph transversals, and machine learning”, In Proceedings of the 16th ACM SIGACT-SIGMOD-SIGART Symposium on Principles of Database Systems, pp. 209-216, 1997.
[15] J. Han, J. Pei, and Y. Yin, “Mining frequent patterns without candidate generation”, In Proceedings of 19th ACM SIGMOD International Conference on Management of Data/Principles of Database Systems, pp. 1-12, 2000.
[16] C. Hidber. “Online Association Rule Mining”, In Proceedings of the 21st International Conference on Very Large Data Bases, pp. 432-444, 1995.
[17] N. Jiang, and L. Gruenwald, “CFI-Stream: Mining Closed Frequent Itemsets in Data Streams”, In Proceedings of 12th ACM SIGKDD International Conference on Knowledge Discovery and Data Mining, pp. 592-597, 2006.
[18] KDDCUP2000. http://www.ecn.purdue.edu/KDDCUP.
[19] D. S. Lee and W. S. Lee. “Finding Maximal Frequent Itemsets over Online Data Streams Adaptively” In Proceedings of the 5th IEEE International Conference on Data Mining. pp. 266-273, 2005.
[20] Mafruz Zaman Ashrafi, David Taniar, Kate A. Smith. “An Efficient Compression Technique for Frequent Itemset Generation in Association Rule Mining”, in Proceedings of 9th Pacific-Asia Conference on Knowledge Discovery and Data Mining, pp. 125-135, 2005.
[21] G. S. Manku and R. Motwani. “Approximate Frequency Counts over Data Streams”, In Proceedings of the 28th International Conference on Very Large Data Bases, pp. 346-357, 2002.
[22] B. Mozafari, H. Thakkar, C. Zaniolo, “Verifying and Mining Freqeunt Patterns from Large Windows over Data Streams”, In Proceedings of 24th International Conference on Data Engineering, pp. 179-188, 2008.
[23] N. Pasquier, Y. Bastide, R. Taouil, and L. Lakhal, “Discovering frequent closed itemsets for association rules”, In Proceedings of 15th International Conference on Database Theory, pp. 398-416, 1999.
[24] H. J. Woo & W. S. Lee. “estMax: Tracing Maximal Frequent Item Sets Instantly over Online Transactional Data Streams”, In Journal of IEEE Transactions on Knowledge and Data Engineering, vol. 21, no. 10, pp. 1418-1431, 2009.
[25] D. Xin, J. Han, X. Yan, and H. Cheng. “On compressing frequent patterns”, In Journal of Data and Knowledge Engineering, vol. 60, no. 1, pp. 5-29, 2007.
[26] Z. Zheng, R. Kohavi, L. Mason, “Real world performance of association rule algorithms”, In Proceedings of the 7th ACM SIGKDD international conference on Knowledge discovery and data mining, pp. 401-406, 2001.

What is claimed is:

1. A method for finding frequent itemsets from data streams, the method comprising:
(a) generating a plurality of projection tractions by projecting generated transactions;
(b) mining each of the plurality of projection transactions by using a plurality of first layer prefix trees;
(c) compressing the frequent itemsets generated at the first layer prefix tree to generate compressed itemsets; and
(d) merging the generated compressed itemsets and mining the merged compressed itemsets by using a second layer prefix tree.

2. The method of claim 1, wherein during step (b), the plurality of first layer prefix trees represents m-th first layer prefix tree by Pm.k {P_{1.k}, P_{2.k}, . . . , P_{m.k}} (m≧2) when the transaction Tₖ (where k is TID) is provided.

3. The method of claim 2, wherein during step (b), the projection transaction T_{m.k} corresponding to the P_{m.K} is represented as follow.
Tₖ={T_{1.k}∪T_{2.k}∪ . . . ∪T_{m.k}}_{(T}_{_{1.k}}_{∩T}_{_{2.k}}_{∩ . . . ∩T}_{_{m.k}}_{=Ø)}

4. The method of claim 1, wherein steps (c) and (d) are performed when the frequent itemsets corresponding to a power set of the projection transaction is present in the first layer prefix tree during step (b).

5. The method of claim 3, wherein step (c) generates the compressed itemsets when the frequent itemsets x and y generated at the first layer prefix tree have a difference in support smaller than a predetermined threshold value ω(0≦ω≦1) while having a relationship of a subset with a superset.

6. The method of claim 2, wherein the merge of the compressed itemsets during step (d) is performed in a type that concatenates a first compressed itemset generated at the first layer prefix tree to m-th compressed itemset generated at the first layer prefix tree.

7. The method of claim 6, wherein when the new transaction Tₖ is generated, the second layer prefix tree is represented by Bₖ and when tuples generated by the merge results of the compressed itemsets is the sub-transaction Uₖ, step (d) includes updating appearance frequency and node performed while finding Bₖ₋₁ by a dictionary order of the items of the Uₖ.

8. The method of claim 7, wherein the updating of the appearance frequency and node sums items corresponding to two first layer prefix trees of the sub-transactions and increases the appearance frequency for each node found while finding the Bₖ₋₁.

9. The method of claim 7, wherein step (d) further includes newly adding important itemsets that are not managed at the Bₖ₋₁ among the itemsets of the Uₖ to the second layer prefix tree.

10. The method of claim 1, further comprising finding the frequent itemsets that circulates the second layer prefix tree by a depth-first finding method and extracts nodes each of which the support is a predetermined minimum support or more.

11. The method of claim 10, wherein the finding of the frequent itemsets finds the frequent itemsets, including the itemsets of the first layer prefix tree.

12. The method of claim 11, wherein the finding of the frequent itemsets at the second layer prefix tree finds the frequent itemsets, having the minimum support equal to or lower than the finding of the frequent itemsets at the first layer prefix tree.

13. The method of claim 5, further comprising estimating the appearance frequency of any item that can be generated by the nodes having the compressed itemsets as the item when ω>0.

14. The method of claim 13, wherein the estimating of the appearance frequency of any item is performed by using the value of the appearance frequency of the compressed itemsets as the appearance frequency of any item.

15. A recording medium readable with a computer recording program for executing a method for finding frequent itemsets from data streams, the method comprising:
generating a plurality of projection tractions by projecting generated transactions;
mining each of the plurality of projection transactions by using a plurality of first layer prefix trees;
compressing the frequent itemsets generated at the first layer prefix tree to generate compressed itemsets; and
merging the generated compressed itemsets and mining the merged compressed itemsets by using a second layer prefix tree.
